(19) United States
(12) Patent Application Publication
(10) Pub. No.: US 2025/0353235 A1
(43) Pub. Date: Nov. 20, 2025

(54) WET MASTERBATCH PRODUCTION LINE BASED ON HIGH-SPEED IMPINGING STREAM REACTION

(71) Applicant: QINGDAO HEIMAO NEW MATERIAL RESEARCH INSTITUTE CO., LTD., Qingdao (CN)

(72) Inventors: Lu An, Qingdao (CN); Qingbin Zhang, Qingdao (CN); Youbin Fu, Qingdao (CN); Lu Shao, Qingdao (CN); Hong Wang, Qingdao (CN); Yuming Shi, Qingdao (CN); Yi Li, Qingdao (CN)

(73) Assignee: QINGDAO HEIMAO NEW MATERIAL RESEARCH INSTITUTE CO., LTD., Qingdao (CN)

(21) Appl. No.: 19/287,794

(22) Filed: Jul. 31, 2025

Related U.S. Application Data
(63) Continuation of application No. PCT/CN2024/080576, filed on Mar. 7, 2024.

(51) Int. Cl. B29C 48/00; B29C 48/07; B29C 48/88; B29C 48/92; B29K 7/00; B29K 507/04; B29L 7/00; C08C 1/16; C08J 3/215; C08K 3/04

(52) U.S. Cl. CPC B29C 48/022; B29C 48/0019; B29C 48/07; B29C 48/9135; B29C 48/92; C08C 1/16; C08J 3/215; C08K 3/04; B29C 2948/9218; B29C 2948/92333; B29C 2948/92857; B29K 2007/00; B29K 2507/04; B29L 2007/002; C08J 2321/02

(57) ABSTRACT

The wet masterbatch production line based on high-speed impinging stream reaction is provided, and includes: the mixing unit, configured for mixing and standing carbon black and latex to obtain granular rubber material; the dehydration unit, configured for performing dehydrating treatment on granular rubber material after standing to obtain flocculent rubber material; the conveying and refining unit, configured for conveying and refining dehydrated flocculent rubber material to obtain sheet rubber material; the cooling treatment unit, configured for cooling, and folding and stacking refined sheet rubber material; and the control unit, configured for automatically controlling the mixing unit, the dehydration unit, the conveying and refining unit and the cooling treatment unit. The working state of the extrusion-dehydration-expansion-drying integrated machine is accurately controlled, so that the rubber material generates heat at a certain internal pressure, a certain stirring rotating speed and a certain shearing speed.

### CROSS-REFERENCE TO RELATED APPLICATIONS

This application is a continuation of PCT/CN2024/080576, filed on Mar. 7, 2024 and claims priority of Chinese Patent Application No. 2023100943550, filed on Jan. 31, 2023, the contents of which are hereby incorporated by reference.

### TECHNICAL FIELD

The disclosure relates to the technical field of rubber wet production lines, and in particular to a wet masterbatch production line based on high-speed impinging stream reaction.

### BACKGROUND

With the continuous progress of science and technology and the continuous development of materials science, the materials used by human beings are also updated and improved. Polymer materials and products thereof have occupied all fields, industries and departments in life, from a certain part of the space shuttle to a small screw, it is possible to use polymer materials. As an important strategic material, rubber is widely used in the fields of national economy, high technology and national defense and military industry. However, due to low strength, low modulus, poor wear resistance and fatigue resistance, rubber is not practical, so most rubber needs to be filled with reinforcing agent. In the prior art, carbon black and silica are widely used as main reinforcing agents in rubber products, and the preparation and application of emerging filler/rubber composites including graphene, carbon nanotubes and carbon-carbon composites have also become research hotspots.

As the newly produced rubber material often contains a large amount of water and a small amount of unpolymerized monomer, it needs to be dehydrated by extrusion, and the rubber material is extruded by the screw of the extrusion-dehydration-expansion-drying integrated machine and the water in the rubber material is extruded out, and then the rubber material is extruded out of the template hole, and finally it is cut. In the process of processing, the internal pressure, stirring speed, shearing speed, etc. all affect the final processing result. However, it is not a simple matter how to select these parameters for the rubber material just produced, so it is an urgent problem to make the water volatilization amount in the rubber material meet the qualified index requirements.

### SUMMARY

The technical problem to be solved by the disclosure is that the box transformer measuring and controlling device in the prior art may not accurately control the water volatilization amount of the rubber material in the extrusion-dehydration-expansion-drying integrated machine.

In order to solve the above technical problems, the disclosure provides a wet masterbatch production line based on high-speed impinging stream reaction, which includes:
a mixing unit, configured for mixing and standing carbon black and latex to obtain granular rubber material;
a dehydration unit, connected behind the mixing unit and configured for performing dehydrating treatment on granular rubber material after standing to obtain flocculent rubber material;
a conveying and refining unit, connected behind the dehydration unit and configured for conveying and refining dehydrated flocculent rubber material to obtain sheet rubber material;
a cooling treatment unit, connected behind the conveying and refining unit and configured for cooling, and folding and stacking refined sheet rubber material; and
a control unit, configured for automatically controlling the mixing unit, the dehydration unit, the conveying and refining unit and the cooling treatment unit.

Further, the dehydration unit includes:
an extrusion-dehydration-expansion-drying integrated machine, configured for extruding, dehydrating, expanding and drying rubber material;
a weight detection device, arranged at a front end of the extrusion-dehydration-expansion-drying integrated machine and configured for detecting weight of rubber material before entering the extrusion-dehydration-expansion-drying integrated machine; and
a moisture analyzer, arranged on the extrusion-dehydration-expansion-drying integrated machine and configured for detecting moisture content of rubber material dehydrated by the extrusion-dehydration-expansion-drying integrated machine;
where the control unit includes:
an acquisition module, respectively connected with the weight detection device and the moisture analyzer and configured for acquiring data detected by the weight detection device and the moisture analyzer;
a processing module, configured for processing detected data; and
a control module, connected with the extrusion-dehydration-expansion-drying integrated machine and configured for controlling working states of the extrusion-dehydration-expansion-drying integrated machine.

Further, the acquisition module continues to acquire weight ΔG of the rubber material before entering the extrusion-dehydration-expansion-drying integrated machine, and the control module is configured for controlling working conditions of the extrusion-dehydration-expansion-drying integrated machine;
the processing module is configured for setting a weight preset value G0 of the rubber material, and the processing module sets a weight difference value g1 of first preset rubber material, a weight difference value g2 of second preset rubber material, a weight difference value g3 of third preset rubber material and a weight difference value g4 of fourth preset rubber material, and g1<g2<g3<g4; the processing module is further configured for setting a first preset working condition matrix A1 (a1, b1, c1), a second preset working condition matrix A2 (a2, b2, c2), a third preset working condition matrix A3 (a3, b3, c3) and a fourth preset working condition matrix A4 (a4, b4, c4), where a1 to a4 sequentially are first to fourth preset internal pressures; and a1<a2<a3<a4, b1 to b4 sequentially are first to fourth preset stirring speeds, and b1<b2<b3<b4, c1 to c4 sequentially are first to fourth preset shearing speeds, and c1<c2<c3<c4;
a preset working condition matrix A is selected as a working condition of the extrusion-dehydration-expansion-drying integrated machine according to a difference value between the weight ΔG of the rubber material in the extrusion-dehydration-expansion-drying integrated machine and a weight preset value G0 of setting rubber material;
when ΔG−G0≤g1, the first preset working condition matrix A1 is selected as the working condition of the extrusion-dehydration-expansion-drying integrated machine;
when g1<ΔG−G0≤g2, the second preset working condition matrix A2 is selected as the working condition of the extrusion-dehydration-expansion-drying integrated machine;
when g2<ΔG−G0≤g3, the third preset working condition matrix A3 is selected as the working condition of the extrusion-dehydration-expansion-drying integrated machine;
when g3<ΔG−G0≤g4, the fourth preset working condition matrix A4 is selected as the working condition of the extrusion-dehydration-expansion-drying integrated machine;
where, when an i-th preset working condition matrix Ai is selected as the working condition of the extrusion-dehydration-expansion-drying integrated machine, the control module controls the extrusion-dehydration-expansion-drying integrated machine to work at an i-th preset internal pressure ai, the control module further controls the extrusion-dehydration-expansion-drying integrated machine to work at an i-th preset stirring speed bi, the control module further controls the extrusion-dehydration-expansion-drying integrated machine to work at an i-th preset shearing speed c1, and i=1, 2, 3, 4.

Further, the processing module is further configured for setting water content T1 of the first preset rubber material dehydrated by the extrusion-dehydration-expansion-drying integrated machine, water content T2 of the second preset rubber material dehydrated by the extrusion-dehydration-expansion-drying integrated machine, water content T3 of the third preset rubber material dehydrated by the extrusion-dehydration-expansion-drying integrated machine and water content T4 of the fourth preset rubber material dehydrated by the extrusion-dehydration-expansion-drying integrated machine, and T1<T2<T3<T4; the acquisition module is further configured for setting a first preset correction coefficient m1, a second preset correction coefficient m2, a third preset correction coefficient m3 and a fourth preset correction coefficient m4, and 1<m1<m2<m3<m4<1.3;
the acquisition module is further configured for acquiring water content ΔT of the rubber material dehydrated by the extrusion-dehydration-expansion-drying integrated machine, and the acquisition module is further configured for selecting a preset correction coefficient to correct a working condition in the i-th preset working condition matrix Ai according to a relationship between the water content ΔT of the rubber material dehydrated by the extrusion-dehydration-expansion-drying integrated machine and each preset water content T of the rubber material dehydrated by the extrusion-dehydration-expansion-drying integrated machine when the i-th preset working condition matrix Ai is selected as the working condition of the extrusion-dehydration-expansion-drying integrated machine;
when ΔT≤T1, the working condition in the i-th preset working condition matrix Ai is not corrected;
when T1<ΔT≤T2, the first preset correction coefficient m1 is selected to correct Ai, being Ai (ai*m1, bi*m1, c1*m1) after correction;
when T2<ΔT≤T3, the second preset correction coefficient m2 is selected to correct Ai, being Ai (ai*m2, bi*m2, c1*m2) after correction;
when T3<ΔT≤T4, the third preset correction coefficient m3 is selected to correct Ai, being Ai (ai*m3, bi*m3, c1*m3) after correction; and
when T4<ΔT, the fourth preset correction coefficient m4 is selected to correct Ai, being Ai (ai*m4, bi*m4, c1*m4) after correction.

Further, the mixing unit includes:
a latex storage tank, configured for storing the latex;
a carbon black slurry storage tank, configured for storing carbon black slurry; and
composite static tanks, respectively connected with the latex storage tank and the carbon black slurry storage tank, and configured for mixing and standing the latex and the carbon black slurry for storage.

Further, a discharge port of the carbon black slurry storage tank is provided with a high-speed jet pump for injecting the carbon black slurry into the composite static tanks at a high speed; and
a discharge port of the latex storage tank is provided with a low-speed jet pump for injecting the latex into the composite static tanks at a low speed.

Further, the dehydration unit further includes:
a vibrating dehydration screen, arranged at front of the extrusion-dehydration-expansion-drying integrated machine and configured for removing free water attached to the rubber material through vibration; and
a vibrating fluidized bed, arranged behind the extrusion-dehydration-expansion-drying integrated machine and configured for drying the rubber material by blowing.

Further, the vibrating fluidized bed includes:
a hot air system, arranged on the vibrating fluidized bed and configured for auxiliary drying of the rubber material; and
a cold air system, arranged on the vibrating fluidized bed and configured for cooling the rubber material.

Further, the conveying and refining unit includes:
a belt conveyor, configured for conveying the rubber material;
a twin-screw extruder, arranged behind the belt conveyor and configured for shearing the rubber material into twin-screw shape rubber material;
a screw conveyor, arranged behind the twin-screw extruder and configured for conveying sheared twin-screw shape rubber material; and
an open mill, arranged behind the screw conveyor and configured for refining the twin-screw shape rubber material into sheet-structured rubber material.

Further, the cooling treatment unit includes:
a water cooling device, configured for cooling the rubber material;
an air drying box, arranged behind the water cooling device and configured for removing moisture on the rubber material; and
a laminator, arranged behind the air drying box and configured for stacking the sheet-structured rubber material.

Compared with the prior art, the wet masterbatch production line based on high-speed impinging stream reaction in the embodiment of the disclosure has the following beneficial effects.

The mixing unit is configured for mixing and standing carbon black and latex to obtain granular rubber material; the dehydration unit is configured for performing dehydrating treatment on granular rubber material after standing to obtain flocculent rubber material; the conveying and refining unit is configured for conveying and refining dehydrated flocculent rubber material to obtain sheet rubber material; the cooling treatment unit is configured for cooling, and folding and stacking refined sheet rubber material; and the control unit is configured for automatically controlling the mixing unit, the dehydration unit, the conveying and refining unit and the cooling treatment unit. According to the disclosure, the working state of the extrusion-dehydration-expansion-drying integrated machine is accurately controlled, so that the rubber material generates heat at a certain internal pressure, a certain stirring rotating speed and a certain shearing speed, and energy reserve of the temperature and pressure of expansion and flash evaporation of the rubber material are achieved; and when the rubber material is discharged indoors, the water volatilization amount in the rubber material reaches the qualified index requirements due to the sudden drop of pressure and temperature.

### BRIEF DESCRIPTION OF THE DRAWINGS

FIG. 1 is a schematic structural diagram of a wet masterbatch production line based on high-speed impinging stream reaction according to embodiments of the disclosure;

FIG. 2 is a schematic structural diagram of a mixing unit of the wet masterbatch production line based on high-speed impinging stream reaction according to embodiments of the disclosure;

FIG. 3 is a schematic structural diagram of a dehydration unit of the wet masterbatch production line based on high-speed impinging stream reaction according to embodiments of the disclosure;

FIG. 4 is a schematic structural diagram of a conveying and refining unit of the wet masterbatch production line based on high-speed impinging stream reaction according to embodiments of the disclosure;

FIG. 5 is a schematic structural diagram of a cooling treatment unit of the wet masterbatch production line based on high-speed impinging stream reaction according to embodiments of the disclosure; and

FIG. 6 is a schematic connection diagram of the control unit of the wet masterbatch production line based on high-speed impinging stream reaction according to embodiments of the disclosure.

List of reference characters: 1 mixing unit; 2 dehydration unit; 3 conveying and refining unit; 4 cooling treatment unit; 5 latex storage tank; 6 carbon black slurry storage tank; 7 composite static tank; 8 high-speed jet pump; 9 low-speed jet pump; 10 vibration dehydration screen; 11 extrusion-dehydration-expansion-drying integrated machine; 12 vibrating fluidized bed; 13 belt conveyor; 14 twin-screw extruder; 15 screw conveyor; 16 open mill; 17 water cooling device; 18 air drying box; 19 laminator; 20 weight detection device; 21 moisture analyzer; 22 hot air system; 23 cold air system; and 24 control unit.

### DETAILED DESCRIPTION OF THE EMBODIMENTS

In the following, the specific embodiments of the disclosure will be described in further detail with reference to the attached drawings and embodiments. The following embodiments are used to illustrate the disclosure, but are not intended to limit the scope of the disclosure.

In the description of the disclosure, it should be understood that the azimuth or positional relationship indicated by the terms “center”, “up”, “down”, “front”, “back”, “left”, “right”, “vertical”, “horizontal”, “top”, “bottom”, “inside” and “outside” is based on the azimuth or positional relationship shown in the attached drawings, only for the convenience of describing the disclosure and simplifying the description, and may not indicate or imply that the referred device or element must have a specific orientation, be constructed and operated in a specific orientation, so it may not be understood as a limitation of the disclosure.

The terms “first” and “second” are only used for descriptive purposes, and may not be understood as indicating or implying relative importance or implicitly indicating the number of indicated technical features. Therefore, the features defined as “first” and “second” may include one or more of these features explicitly or implicitly. In the description of the disclosure, unless otherwise specified, “multiple” means two or more.

In the description of the disclosure, it should be noted that unless otherwise specified and limited, the terms “installation”, “connection” and “connecting” should be broadly understood, for example, fixed connection may be used, detachable connection or integrated connection may be used. A mechanical connection or an electrical connection may be used. A direct connection may be used, a indirect connection through an intermediate medium may be used, and connection inside two elements may be used. For those skilled in the art, the specific meanings of the above terms in the disclosure may be understood in specific circumstances.

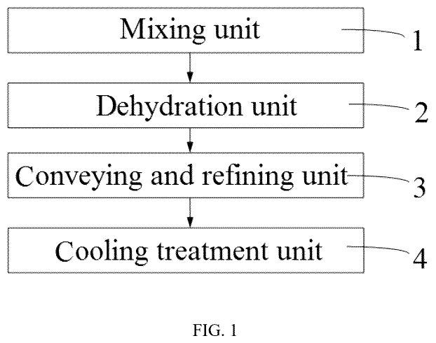

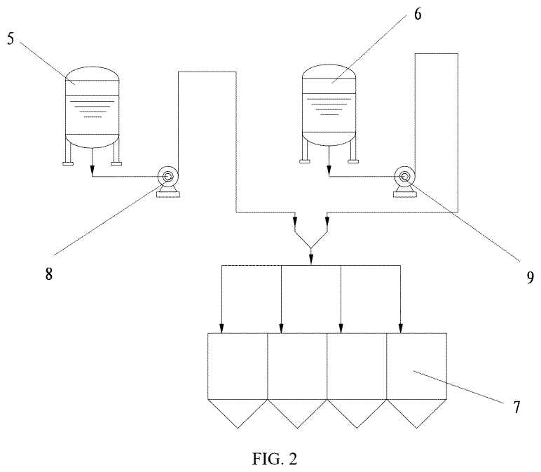

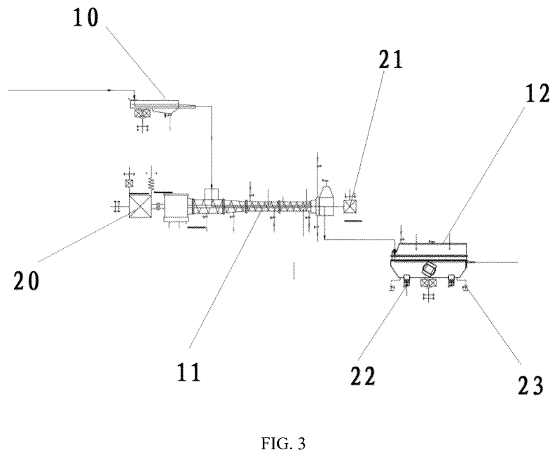

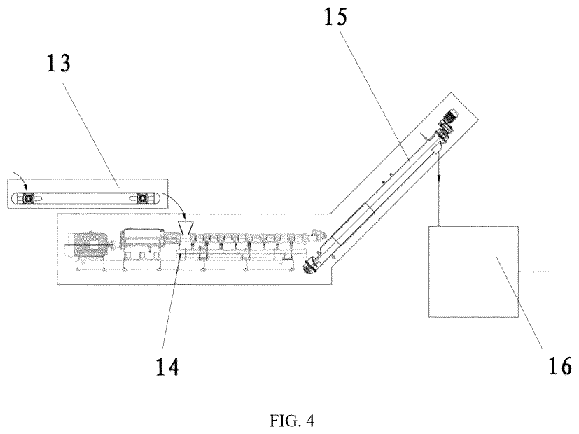

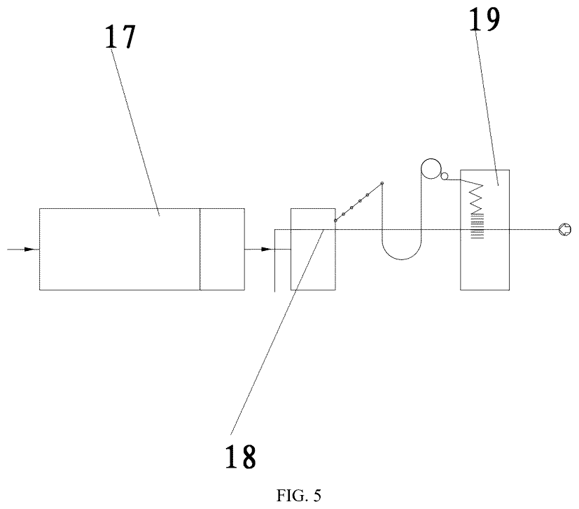

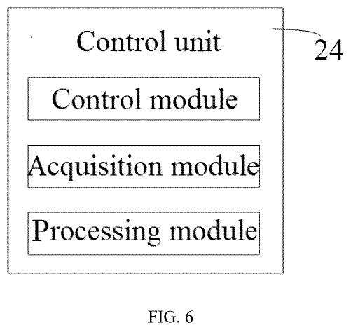

As shown in FIGS. 1-6, in the embodiments of the disclosure, a wet masterbatch production line based on high-speed impinging stream reaction is provided, which includes: a mixing unit 1, a dehydration unit 2, a conveying and refining unit 3, a cooling treatment unit 4 and a control unit 24. The mixing unit 1 is configured for mixing and standing carbon black and latex to obtain granular rubber material; the dehydration unit 2 is connected behind the mixing unit 1 and configured for performing dehydrating treatment on granular rubber material after standing to obtain flocculent rubber material; the conveying and refining unit 3 is connected behind the dehydration unit 2 and configured for conveying and refining dehydrated flocculent rubber material to obtain sheet rubber material; the cooling treatment unit 4 is connected behind the conveying and refining unit 3 and configured for cooling, and folding and stacking refined sheet rubber material; and the setting position of the control unit 24 may be installed according to actual needs and configured for automatically controlling the mixing unit 1, the dehydration unit 2, the conveying and refining unit 3 and the cooling treatment unit 4.

Further, by accurately controlling the working state of the extrusion-dehydration-expansion-drying integrated machine 11, so that the rubber material generates heat at a certain internal pressure, a certain stirring rotating speed and a certain shearing speed, and energy reserve of the temperature and pressure of expansion and flash evaporation of the rubber material are achieved; and when the rubber material is discharged indoors, the water volatilization amount in the rubber material reaches the qualified index requirements due to the sudden drop of pressure and temperature.

In the embodiments of the disclosure, the wet masterbatch production line based on high-speed impinging stream reaction is provided, and the dehydration unit 2 includes:
an extrusion-dehydration-expansion-drying integrated machine 11, configured for extruding, dehydrating, expanding and drying rubber material.

Specifically, when the extrusion-dehydration-expansion-drying integrated machine 11 works, the motor is started, and the screw is driven to rotate through the coupling and gear reducer. The rubber material from which most of the free water has been removed in the previous procedure is added by the hopper, and compressed by the conical screw section, so that part of the free water in the rubber material is discharged into the water receiving tank through the drainage screen for recycling. Under the continuous push of the screw, the rubber material enters the first-stage straight barrel and the second-stage straight barrel in turn. Under the joint action of the special design of the shallow spiral groove and local spiral of the screw and the continuous increase of compression ratio, and the shear screw, the rubber material is strongly stirred and frictionally sheared to generate heat. At the same time, the pressure in the machine may be appropriately adjusted by the frequency conversion motor under the speed adjustment, so that uniform stirring, more heat generation and rapid temperature rise are realized, and the energy reserve of the temperature and pressure of rubber material expansion and flash evaporation is achieved. When the rubber material is discharged from the die hole of the die plate mechanism and enters the indoor environment, the rubber material may rapidly realize expansion and flash evaporation due to the sudden drop of pressure and temperature, so that the water volatilization amount in the rubber material reaches the qualified index requirements. The extrusion-dehydration-expansion-drying integrated machine 11 may reduce the water content in the rubber material to below 2%.

A weight detection device 20 is arranged at a front end of the extrusion-dehydration-expansion-drying integrated machine 11 and configured for detecting weight of rubber material before entering the extrusion-dehydration-expansion-drying integrated machine 11; and
a moisture analyzer 21 is arranged on the extrusion-dehydration-expansion-drying integrated machine 11 and configured for detecting moisture content of rubber material dehydrated by the extrusion-dehydration-expansion-drying integrated machine 11.

Preferably, the moisture analyzer 21 is a rubber material moisture analyzer, which may be widely used to quickly determine the moisture content of PP plastic rubber, PE plastic rubber, PVC plastic rubber, PS plastic rubber, PA plastic rubber, PC plastic rubber, PET plastic rubber, PPS plastic rubber, plastic rubber additives, plastic rubber raw materials, polystyrene acrylonitrile, polyamide, polypropylene, polycarbonate, plastic rubber granule, plastic rubber particles, plastic granule, and plastic particles, and has the advantages of: first, small volume, light weight and simple structure; second, not affected by the environment and humidity, without auxiliary equipment; third, the operation is simple and there is no need for installation and debugging training; fourth, high efficiency and speed, and the overall operation may not exceed 10 minutes; fifth, high precision, electromagnetic force weighing sensor to ensure the accuracy of weighing precision (more than one ten thousand of the international weighing system sensors use electromagnetic force balance sensor); sixth, a variety of analysis methods, fully automatic, timed, semi-automatic to meet all kinds of analysis methods; seventh, standard RS232 communication interface-convenient to connect printers, computers and other peripheral devices, meeting the requirements of FDA/HACCP format; eighth, plastic moisture detector, the heating mode of the annular quartz tungsten halogen Infrared ring lamp of the plastic moisture analyzer 21 may be directly heated from the inside of the material, which greatly shortens the drying time, and also has the advantages of uniform heating, cleanness, high efficiency and energy saving (tungsten halogen ring lamp injects halogen gas such as iodine or bromine into infrared lamp, and at high temperature, the sublimated tungsten wire reacts chemically with halogen, and the sublimated tungsten may re-solidify on the tungsten wire to form a balanced cycle, so as to prevent the tungsten wire from breaking prematurely. Therefore, tungsten halogen lamps have a longer life than ordinary infrared lamp).

The control unit 24 includes:
an acquisition module, respectively connected with the weight detection device 20 and the moisture analyzer 21 and configured for acquiring data detected by the weight detection device 20 and the moisture analyzer 21;
a processing module, configured for processing detected data; and
a control module, connected with the extrusion-dehydration-expansion-drying integrated machine 11 and configured for controlling working states of the extrusion-dehydration-expansion-drying integrated machine 11.

In embodiments of the disclosure, the wet masterbatch production line based on high-speed impinging stream reaction is provided. The acquisition module continues to acquire weight ΔG of the rubber material before entering the extrusion-dehydration-expansion-drying integrated machine 11, and the control module is configured for controlling working conditions of the extrusion-dehydration-expansion-drying integrated machine 11;
the processing module is configured for setting a weight preset value G0 of the rubber material, and the processing module sets a weight difference value g1 of first preset rubber material, a weight difference value g2 of second preset rubber material, a weight difference value g3 of third preset rubber material and a weight difference value g4 of fourth preset rubber material, and g1<g2<g3<g4; the processing module is further configured for setting a first preset working condition matrix A1 (a1, b1, c1), a second preset working condition matrix A2 (a2, b2, c2), a third preset working condition matrix A3 (a3, b3, c3) and a fourth preset working condition matrix A4 (a4, b4, c4), where a1 to a4 sequentially are first to fourth preset internal pressures; and a1<a2<a3<a4, b1 to b4 sequentially are first to fourth preset stirring speeds, and b1<b2<b3<b4, c1 to c4 sequentially are first to fourth preset shearing speeds, and c1<c2<c3<c4;
a preset working condition matrix A is selected as a working condition of the extrusion-dehydration-expansion-drying integrated machine 11 according to a difference value between the weight ΔG of the rubber material in the extrusion-dehydration-expansion-drying integrated machine 11 and a weight preset value G0 of setting rubber material;
when ΔG−G0≤g1, the first preset working condition matrix A1 is selected as the working condition of the extrusion-dehydration-expansion-drying integrated machine 11;
when g1<ΔG−G0≤g2, the second preset working condition matrix A2 is selected as the working condition of the extrusion-dehydration-expansion-drying integrated machine 11;
when g2<ΔG−G0≤g3, the third preset working condition matrix A3 is selected as the working condition of the extrusion-dehydration-expansion-drying integrated machine 11;
when g3<A G−G0≤g4, the fourth preset working condition matrix A4 is selected as the working condition of the extrusion-dehydration-expansion-drying integrated machine 11;
when an i-th preset working condition matrix Ai is selected as the working condition of the extrusion-dehydration-expansion-drying integrated machine 11, the control module controls the extrusion-dehydration-expansion-drying integrated machine 11 to work at an i-th preset internal pressure ai, the control module further controls the extrusion-dehydration-expansion-drying integrated machine 11 to work at an i-th preset stirring speed bi, the control module further controls the extrusion-dehydration-expansion-drying integrated machine 11 to work at an i-th preset shearing speed c1, and i=1, 2, 3, 4.

Specifically, the working conditions of the extrusion-dehydration-expansion-drying integrated machine 11 are selected according to the difference value between the weight of the rubber material in the extrusion-dehydration-expansion-drying integrated machine 11 and the setting weight preset value of the rubber material, and the rubber material generates heat at a certain internal pressure, a certain stirring rotating speed and a certain shearing speed, so that the water volatilization amount in the produced rubber material may meet the qualified index requirements.

In embodiments of the disclosure, the wet masterbatch production line based on high-speed impinging stream reaction is provided. The processing module is further configured for setting water content T1 of the first preset rubber material dehydrated by the extrusion-dehydration-expansion-drying integrated machine 11, water content T2 of the second preset rubber material dehydrated by the extrusion-dehydration-expansion-drying integrated machine 11, water content T3 of the third preset rubber material dehydrated by the extrusion-dehydration-expansion-drying integrated machine 11 and water content T4 of the fourth preset rubber material dehydrated by the extrusion-dehydration-expansion-drying integrated machine 11, and T1<T2<T3<T4; the acquisition module is further configured for setting a first preset correction coefficient m1, a second preset correction coefficient m2, a third preset correction coefficient m3 and a fourth preset correction coefficient m4, and 1<m1<m2<m3<m4<1.3;
the acquisition module is further configured for acquiring water content ΔT of the rubber material dehydrated by the extrusion-dehydration-expansion-drying integrated machine 11, and the acquisition module is further configured for selecting a preset correction coefficient to correct a working condition in the i-th preset working condition matrix Ai according to a relationship between the water content ΔT of the rubber material dehydrated by the extrusion-dehydration-expansion-drying integrated machine 11 and each preset water content T of the rubber material dehydrated by the extrusion-dehydration-expansion-drying integrated machine 11 when the i-th preset working condition matrix Ai is selected as the working condition of the extrusion-dehydration-expansion-drying integrated machine 11;
when ΔT≤T1, the working condition in the i-th preset working condition matrix Ai is not corrected;
when T1<ΔT≤T2, the first preset correction coefficient m1 is selected to correct Ai, being Ai (ai*m1, bi*m1, c1*m1) after correction;
when T2<ΔT≤T3, the second preset correction coefficient m2 is selected to correct Ai, being Ai (ai*m2, bi*m2, c1*m2) after correction;
when T3<ΔT≤T4, the third preset correction coefficient m3 is selected to correct Ai, being Ai (ai*m3, bi*m3, c1*m3) after correction; and;
when T4<ΔT, the fourth preset correction coefficient m4 is selected to correct Ai, being Ai (ai*m4, bi*m4, c1*m4) after correction.

Specifically, according to the relationship between the water content of rubber material dehydrated by the extrusion-dehydration-expansion-drying integrated machine 11 and the preset water content of rubber material dehydrated by the extrusion-dehydration-expansion-drying integrated machine 11, the working conditions of the extrusion-dehydration-expansion-drying integrated machine 11 are corrected to ensure that the extrusion-dehydration-expansion-drying integrated machine 11 may work according to the set expectation, so as to achieve the final expected result and ensure that the produced rubber material meets the index requirements.

In embodiments of the disclosure, the wet masterbatch production line based on high-speed impinging stream reaction is provided. The mixing unit 1 includes:
a latex storage tank 5, being a 4.5 m³ storage tank, the latex storage tank 5 is configured for store latex;
a carbon black slurry storage tank 6, being a 10.5 m³ storage tank, the carbon black slurry storage tank 6 is configured for storing carbon black slurry;
composite static tanks 7, including four 5.5 m³ storage tanks, the composite static tanks 7 are respectively connected with the latex storage tank 5 and the carbon black slurry storage tank 6 for mixing and standing latex and carbon black slurry for storage.

Specifically, the middle of the composite static tank 7 is provided with a reactor chamber for the composite reaction of carbon black slurry and latex, and the bottom of the composite static tank 7 is provided with a pneumatic valve, which may control the outflow of rubber material.

In embodiments of the disclosure, the wet masterbatch production line based on high-speed impinging stream reaction is provided. a discharge port of the carbon black slurry storage tank 6 is provided with a high-speed jet pump 8 for injecting the carbon black slurry into the composite static tanks 7 at a high speed; and
a discharge port of the latex storage tank 5 is provided with a low-speed jet pump 9 for injecting the latex into the composite static tanks 7 at a low speed.

Specifically, the high-speed jet pump 8 and the low-speed jet pump 9 are inserted into the reactor chamber arranged in the middle of the composite static tank 7 to counterjet two kinds of raw materials.

In embodiments of the disclosure, the wet masterbatch production line based on high-speed impinging stream reaction is provided. The dehydration unit 2 further includes:
a vibrating dehydration screen 10, arranged at front of the extrusion-dehydration-expansion-drying integrated machine 11 and configured for removing free water attached to the rubber material through vibration;
preferably, the vibrating dehydration screen 10 is a vibrating device with a screen, and the free water attached to the rubber material may be removed by vibration, which may remove more than 30% of the water in the rubber material; and
a vibrating fluidized bed 12, arranged behind the extrusion-dehydration-expansion-drying integrated machine 11 and configured for drying the rubber material by blowing.

Preferably, the vibration fluidized bed 12 has an amplitude of 14 mm, a frequency of 740 RPM, and a screen surface size of length×width=4000×600 mm; each vibrating fluidized bed 12 has four groups of independent isolation springs.

In embodiments of the disclosure, the wet masterbatch production line based on high-speed impinging stream reaction is provided. The vibrating fluidized bed 12 includes:
a hot air system 22, arranged on the vibrating fluidized bed 12 and configured for auxiliary drying of the rubber material;
preferably, the air supply temperature of the hot air system 22 is 100° C.-110° C.;
a cold air system 23, arranged on the vibrating fluidized bed 12 and configured for cooling the rubber material.

Preferably, the air supply temperature of the cold air system 23 is ≤10° C., which may reduce the temperature of the rubber material to below 50° C.

In embodiments of the disclosure, the wet masterbatch production line based on high-speed impinging stream reaction is provided. The conveying and refining unit 3 includes:
a belt conveyor 13, configured for conveying the rubber material;
a twin-screw extruder 14, arranged behind the belt conveyor 13 and configured for shearing the rubber material into twin-screw shape rubber material;
specifically, the function of the twin-screw extruder 14 is to shear the rubber material to break the molecular weight between the rubber materials, reduce the Mooney viscosity of the rubber material, and make the rubber material easy for subsequent processing and use.
a screw conveyor 15, arranged behind the twin-screw extruder 14 and configured for conveying sheared twin-screw shape rubber material; and
an open mill 16, arranged behind the screw conveyor 15 and configured for refining the twin-screw shape rubber material into sheet-structured rubber material.

Preferably, the open mill 16 is selected as the cone double open mill 16, and the function is to change the dried flocculent rubber material into rubber sheets with a thickness of 10 mm and a width of 400 mm.

In embodiments of the disclosure, the wet masterbatch production line based on high-speed impinging stream reaction is provided. The cooling treatment unit 4 includes:
a water cooling device 17, configured for cooling the rubber material;
preferably, the water cooling device 17 cools the rubber material by setting a water cooling tank and putting the rubber material into the water cooling tank;
an air drying box 18, arranged behind the water cooling device 17 and configured for removing moisture on the rubber material;
preferably, the air drying box 18 adopts air drying at room temperature to perform air drying removal on the moisture of the rubber material;
a laminator 19, arranged behind the air drying box 18 and configured for stacking the sheet-structured rubber material.

Specifically, the function of the laminator 19 is to fold the sheet-structured rubber material and make it easy to stack.

To sum up, the embodiments of the disclosure provide the wet masterbatch production line based on high-speed impinging stream reaction, which includes the mixing unit 1, configured for mixing and standing carbon black and latex to obtain granular rubber material; the dehydration unit 2, configured for performing dehydrating treatment on granular rubber material after standing to obtain flocculent rubber material; the conveying and refining unit 3, configured for conveying and refining dehydrated flocculent rubber material to obtain sheet rubber material; the cooling treatment unit 4, configured for cooling, and folding and stacking refined sheet rubber material; and the control unit 24, configured for automatically controlling the mixing unit 1, the dehydration unit 2, the conveying and refining unit 3 and the cooling treatment unit 4. According to the disclosure, the working state of the extrusion-dehydration-expansion-drying integrated machine 11 is accurately controlled, so that the rubber material generates heat at a certain internal pressure, a certain stirring rotating speed and a certain shearing speed, and energy reserve of the temperature and pressure of expansion and flash evaporation of the rubber material are achieved; and when the rubber material is discharged indoors, the water volatilization amount in the rubber material reaches the qualified index requirements due to the sudden drop of pressure and temperature.

Finally, it should be explained that the above is only the preferred embodiment of the disclosure, and it is not used to limit the disclosure. Although the disclosure has been described in detail with reference to the foregoing embodiments, it is still possible for those skilled in the art to modify the technical scheme described in the foregoing embodiments or to replace some of technical features by equivalents. Any modification, equivalent substitution, improvement, etc. made within the spirit and principle of the disclosure should be included in the protection scope of the disclosure.

What is claimed is:

1. A wet masterbatch production line based on high-speed impinging stream reaction, comprising:
a mixing unit, configured for mixing and standing carbon black and latex to obtain granular rubber material;
a dehydration unit, connected behind the mixing unit and configured for performing dehydrating treatment on granular rubber material after standing to obtain flocculent rubber material;
a conveying and refining unit, connected behind the dehydration unit and configured for conveying and refining dehydrated flocculent rubber material to obtain sheet rubber material;
a cooling treatment unit, connected behind the conveying and refining unit and configured for cooling, and folding and stacking refined sheet rubber material; and
a control unit, configured for automatically controlling the mixing unit, the dehydration unit, the conveying and refining unit and the cooling treatment unit;
wherein the dehydration unit comprises:
an extrusion-dehydration-expansion-drying integrated machine, configured for extruding, dehydrating, expanding and drying rubber material;
a weight detection device, arranged at a front end of the extrusion-dehydration-expansion-drying integrated machine and configured for detecting weight of rubber material before entering the extrusion-dehydration-expansion-drying integrated machine; and
a moisture analyzer, arranged on the extrusion-dehydration-expansion-drying integrated machine and configured for detecting moisture content of rubber material dehydrated by the extrusion-dehydration-expansion-drying integrated machine;
wherein the control unit comprises:
an acquisition module, respectively connected with the weight detection device and the moisture analyzer and configured for acquiring data detected by the weight detection device and the moisture analyzer;
a processing module, configured for processing detected data; and
a control module, connected with the extrusion-dehydration-expansion-drying integrated machine and configured for controlling working states of the extrusion-dehydration-expansion-drying integrated machine;
wherein the acquisition module continues to acquire weight ΔG of the rubber material before entering the extrusion-dehydration-expansion-drying integrated machine, and the control module is configured for controlling working conditions of the extrusion-dehydration-expansion-drying integrated machine;
the processing module is configured for setting a weight preset value G0 of the rubber material, and the processing module sets a weight difference value g1 of first preset rubber material, a weight difference value g2 of second preset rubber material, a weight difference value g3 of third preset rubber material and a weight difference value g4 of fourth preset rubber material, and g1<g2<g3<g4; the processing module is further configured for setting a first preset working condition matrix A1 (a1, b1, c1), a second preset working condition matrix A2 (a2, b2, c2), a third preset working condition matrix A3 (a3, b3, c3) and a fourth preset working condition matrix A4 (a4, b4, c4), wherein a1 to a4 sequentially are first to fourth preset internal pressures; and a1<a2<a3<a4, b1 to b4 sequentially are first to fourth preset stirring speeds, and b1<b2<b3<b4, c1 to c4 sequentially are first to fourth preset shearing speeds, and c1<c2<c3<c4;
a preset working condition matrix A is selected as a working condition of the extrusion-dehydration-expansion-drying integrated machine according to a difference value between the weight ΔG of the rubber material in the extrusion-dehydration-expansion-drying integrated machine and a weight preset value G0 of setting rubber material;
when ΔG−G0≤g1, the first preset working condition matrix A1 is selected as the working condition of the extrusion-dehydration-expansion-drying integrated machine;
when g1<ΔG−G0≤g2, the second preset working condition matrix A2 is selected as the working condition of the extrusion-dehydration-expansion-drying integrated machine;
when g2<ΔG−G0≤g3, the third preset working condition matrix A3 is selected as the working condition of the extrusion-dehydration-expansion-drying integrated machine;
when g3<ΔG−G0≤g4, the fourth preset working condition matrix A4 is selected as the working condition of the extrusion-dehydration-expansion-drying integrated machine;
wherein, when an i-th preset working condition matrix Ai is selected as the working condition of the extrusion-dehydration-expansion-drying integrated machine, the control module controls the extrusion-dehydration-expansion-drying integrated machine to work at an i-th preset internal pressure ai, the control module further controls the extrusion-dehydration-expansion-drying integrated machine to work at an i-th preset stirring speed bi, the control module further controls the extrusion-dehydration-expansion-drying integrated machine to work at an i-th preset shearing speed c1, and i=1, 2, 3, 4;
the processing module is further configured for setting water content T1 of the first preset rubber material dehydrated by the extrusion-dehydration-expansion-drying integrated machine, water content T2 of the second preset rubber material dehydrated by the extrusion-dehydration-expansion-drying integrated machine, water content T3 of the third preset rubber material dehydrated by the extrusion-dehydration-expansion-drying integrated machine and water content T4 of the fourth preset rubber material dehydrated by the extrusion-dehydration-expansion-drying integrated machine, and T1<T2<T3<T4; the acquisition module is further configured for setting a first preset correction coefficient m1, a second preset correction coefficient m2, a third preset correction coefficient m3 and a fourth preset correction coefficient m4, and 1<m1<m2<m3<m4<1.3;
the acquisition module is further configured for acquiring water content ΔT of the rubber material dehydrated by the extrusion-dehydration-expansion-drying integrated machine, and the acquisition module is further configured for selecting a preset correction coefficient to correct a working condition in the i-th preset working condition matrix Ai according to a relationship between the water content ΔT of the rubber material dehydrated by the extrusion-dehydration-expansion-drying integrated machine and each preset water content T of the rubber material dehydrated by the extrusion-dehydration-expansion-drying integrated machine when the i-th preset working condition matrix Ai is selected as the working condition of the extrusion-dehydration-expansion-drying integrated machine;
when ΔT≤T1, the working condition in the i-th preset working condition matrix Ai is not corrected;
when T1<ΔT≤T2, the first preset correction coefficient m1 is selected to correct Ai, being Ai (ai*m1, bi*m1, c1*m1) after correction;
when T2<ΔT≤T3, the second preset correction coefficient m2 is selected to correct Ai, being Ai (ai*m2, bi*m2, c1*m2) after correction;
when T3<ΔT≤T4, the third preset correction coefficient m3 is selected to correct Ai, being Ai (ai*m3, bi*m3, c1*m3) after correction; and
when T4<ΔT, the fourth preset correction coefficient m4 is selected to correct Ai, being Ai (ai*m4, bi*m4, c1*m4) after correction.

2. The wet masterbatch production line based on high-speed impinging stream reaction according to claim 1, wherein the mixing unit comprises:
a latex storage tank, configured for storing the latex;
a carbon black slurry storage tank, configured for storing carbon black slurry; and
composite static tanks, respectively connected with the latex storage tank and the carbon black slurry storage tank, and configured for mixing and standing the latex and the carbon black slurry for storage.

3. The wet masterbatch production line based on high-speed impinging stream reaction according to claim 2, wherein
a discharge port of the carbon black slurry storage tank is provided with a high-speed jet pump for injecting the carbon black slurry into the composite static tanks at a high speed; and
a discharge port of the latex storage tank is provided with a low-speed jet pump for injecting the latex into the composite static tanks at a low speed.

4. The wet masterbatch production line based on high-speed impinging stream reaction according to claim 1, wherein the dehydration unit further comprises:
a vibrating dehydration screen, arranged at front of the extrusion-dehydration-expansion-drying integrated machine and configured for removing free water attached to the rubber material through vibration; and
a vibrating fluidized bed, arranged behind the extrusion-dehydration-expansion-drying integrated machine and configured for drying the rubber material by blowing.

5. The wet masterbatch production line based on high-speed impinging stream reaction according to claim 4, wherein the vibrating fluidized bed comprises:
a hot air system, arranged on the vibrating fluidized bed and configured for auxiliary drying of the rubber material; and
a cold air system, arranged on the vibrating fluidized bed and configured for cooling the rubber material.

6. The wet masterbatch production line based on high-speed impinging stream reaction according to claim 1, wherein the conveying and refining unit comprises:
a belt conveyor, configured for conveying the rubber material;
a twin-screw extruder, arranged behind the belt conveyor and configured for shearing the rubber material into twin-screw shape rubber material;
a screw conveyor, arranged behind the twin-screw extruder and configured for conveying sheared twin-screw shape rubber material; and
an open mill, arranged behind the screw conveyor and configured for refining the twin-screw shape rubber material into sheet-structured rubber material.

7. The wet masterbatch production line based on high-speed impinging stream reaction according to claim 1, wherein the cooling treatment unit comprises:
a water cooling device, configured for cooling the rubber material;
an air drying box, arranged behind the water cooling device and configured for removing moisture on the rubber material; and
a laminator, arranged behind the air drying box and configured for stacking the sheet-structured rubber material.
